(19) United States
(12) Patent Application Publication
(10) Pub. No.: US 2026/0105664 A1
(43) Pub. Date: Apr. 16, 2026

(54) IMAGE PROCESSING SYSTEM, IMAGE PROCESSING METHOD, AND STORAGE MEDIUM

(71) Applicant: CANON KABUSHIKI KAISHA, Tokyo (JP)

(72) Inventors: SHUMA YOKOYAMA, Kanagawa (JP); AKITAKA YOSHIZAWA, Kanagawa (JP)

(21) Appl. No.: 19/384,221

(22) Filed: Nov. 10, 2025

Related U.S. Application Data
(63) Continuation of application No. PCT/JP2024/015151, filed on Apr. 16, 2024.

(30) Foreign Application Priority Data
May 23, 2023 (JP) 2023-084704

(51) Int. Cl. G06T 11/60; G06F 3/16; G06T 7/20

(52) U.S. Cl. CPC G06T 11/60; G06F 3/16; G06T 7/20; G06T 2207/20104; G06V 2201/07

(57) ABSTRACT

There is provided an image processing system. A subject detection unit detects, among a plurality of frames of moving image data accompanied by audio data, a subject of a first type. A subject deletion unit deletes the subject of the first type from one or more frames, among the plurality of frames, in which the subject of the first type is detected. An audio detection unit detects, in the audio data, an audio component corresponding to the subject of the first type. An audio deletion unit deletes the audio component corresponding to the subject of the first type from the audio data.

### CROSS-REFERENCE TO RELATED APPLICATIONS

This application is a Continuation of International Patent Application No. PCT/JP2024/015151, filed Apr. 16, 2024, which claims the benefit of Japanese Patent Application No. 2023-084704, filed May 23, 2023, both of which are hereby incorporated by reference herein in their entirety.

### BACKGROUND

### Field of the Technology

The present disclosure relates to an image processing system, an image processing method, and a storage medium.

### Description of the Related Art

Currently, digital cameras, smartphones and the like having a function for shooting moving images with audio are in widespread use. Moving images with audio shot by a user may show subjects that the user does not want to appear. For example, in the case where the user wants to shoot a moving image of a person, a car that the user does not want in the moving image may appear.

Also, a technology for removing unwanted areas within images so as to leave no trace is currently known (Japanese Patent Laid-Open No. 2007-286734).

Consider the case where a subject that emits audio is deleted from a moving image with audio. In this case, when the moving image with audio is played back, the user may feel a sense of incongruity, since the audio, in which the audio component corresponding to the subject that is not displayed because it was deleted remains, is played back. In this way, the quality of a moving image with audio deteriorates when a subject that emits audio is deleted from the moving image with audio.

### SUMMARY

The present disclosure, in at least some of its aspects, provides a technology that enables a specific subject to be deleted from a moving image with audio, while suppressing deterioration in the quality of the moving image with audio.

According to a first aspect of the present disclosure, there is provided an image processing system comprising at least one processor and/or at least one circuit which functions as: a subject detection unit configured to detect, among a plurality of frames of moving image data accompanied by audio data, a subject of a first type; a subject deletion unit configured to delete the subject of the first type from one or more frames, among the plurality of frames, in which the subject of the first type is detected; an audio detection unit configured to detect, in the audio data, an audio component corresponding to the subject of the first type; and an audio deletion unit configured to delete the audio component corresponding to the subject of the first type from the audio data.

According to a second aspect of the present disclosure, there is provided an image processing method executed by an image processing system, comprising: detecting, among a plurality of frames of moving image data accompanied by audio data, a subject of a first type; deleting the subject of the first type from one or more frames, among the plurality of frames, in which the subject of the first type is detected; detecting, in the audio data, an audio component corresponding to the subject of the first type; and deleting the audio component corresponding to the subject of the first type from the audio data.

According to a third aspect of the present disclosure, there is provided a non-transitory computer-readable storage medium which stores a program for causing a computer to execute an image processing method comprising: detecting, among a plurality of frames of moving image data accompanied by audio data, a subject of a first type; deleting the subject of the first type from one or more frames, among the plurality of frames, in which the subject of the first type is detected; detecting, in the audio data, an audio component corresponding to the subject of the first type; and deleting the audio component corresponding to the subject of the first type from the audio data.

Features of the present disclosure will become apparent from the following description of embodiments with reference to the attached drawings.

### BRIEF DESCRIPTION OF THE DRAWINGS

The accompanying drawings, which are incorporated in and constitute a part of the specification, illustrate embodiments of the disclosure and, together with the description, serve to explain principles of the disclosure.

FIG. 1A is a diagram showing a hardware configuration of an image processing system.

FIG. 1B is a diagram showing a functional configuration of the image processing system according to a first embodiment.

FIG. 2 is a flowchart of image processing executed by the image processing system according to the first embodiment.

FIG. 3A is a diagram illustrating an example of deletion of a subject according to the first embodiment.

FIG. 3B is a diagram illustrating an example of deletion of a subject according to the first embodiment.

FIG. 3C is a diagram illustrating an example of deletion of a subject according to the first embodiment.

FIG. 4A is a diagram illustrating an example of deletion of an audio component according to the first embodiment.

FIG. 4B is a diagram illustrating an example of deletion of an audio component according to the first embodiment.

FIG. 5 is a diagram showing a functional configuration of an image processing system according to a second embodiment.

FIG. 6 is a flowchart of image processing executed by the image processing system according to the second embodiment.

FIG. 7 is a diagram illustrating an example of separation of audio components according to the second embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### Hardware Configuration of Image Processing System

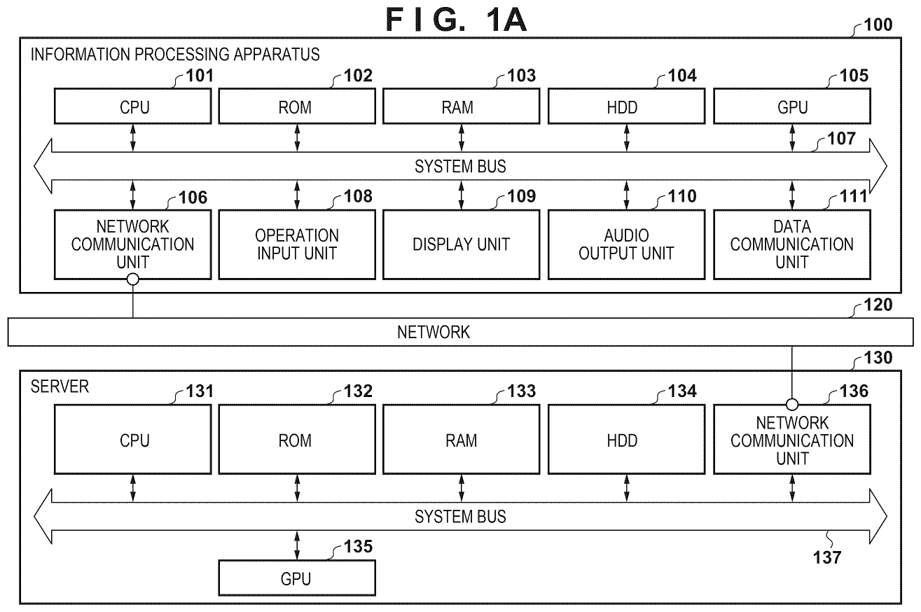

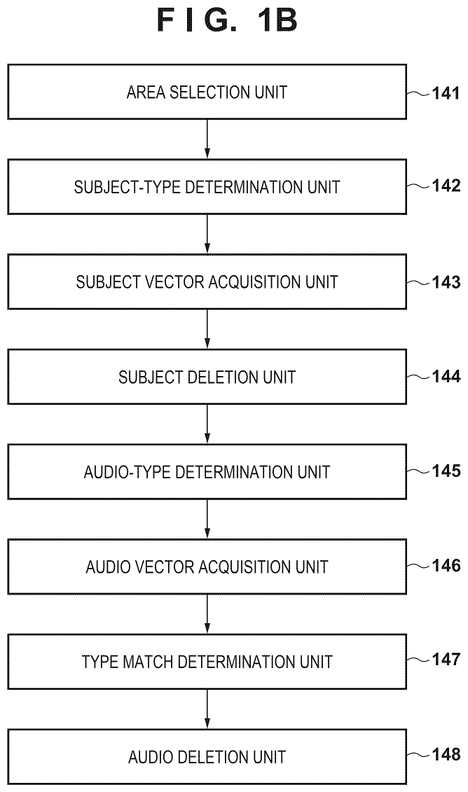

FIG. 1A is a diagram showing the hardware configuration of an image processing system. In FIG. 1A, an information processing apparatus 100 is an apparatus having a moving image editing function, and is a personal computer (PC), a smartphone, or the like, for example. The information processing apparatus 100 includes a CPU 101, a ROM 102, a RAM 103, an HDD 104, a GPU 105, a network communication unit 106, an operation input unit 108, a display unit 109, an audio output unit 110, and a data communication unit 111. These constituent elements of the information processing apparatus 100 are connected to each other via a system bus 107.

The CPU 101 performs overall control of operations of the information processing apparatus 100, by executing programs stored in the ROM 102 or the HDD 104, using the RAM 103 as a work area. Programs executed by the CPU 101 include a moving image editing application program. The ROM 102 is a read-only non-volatile storage medium and stores programs such as firmware. The RAM 103 is a volatile storage medium with respect to which information is readable and writable at high speed, and is used as a work area when the CPU 101 processes information. The HDD 104 is a non-volatile storage medium with respect to which information is readable and writable, and stores an OS, various control programs, application programs, moving image data and audio data for use in moving image editing, and the like.

The GPU 105 cooperates with the CPU 101 to execute processing for moving image editing, learning/inference using machine learning technologies, and the like. In general, GPUs are able to perform efficient computations by processing more data in parallel, compared to CPUs. Thus, in the case where the GPU 105 is used in addition to the CPU 101, inference relating to moving images and audio can be efficiently performed multiple times using a trained model in deep learning. Note that inference processing using a trained model described later may be performed by one of the CPU 101 and the GPU 105.

The network communication unit 106 is an interface for connecting to a server 130 via a network 120. The operation input unit 108 accepts operations from the user, via a keyboard, a mouse, a touch panel, and the like. These operations enable the user to operate the moving image editing application. The display unit 109 is a monitor or a display and displays a graphical user interface (GUI) of the information processing apparatus 100. A GUI of the moving image editing application is also displayed on the display unit 109, and it is possible for the user to edit moving images by operating the GUI. The audio output unit 110 is an audio playback device such as a speaker. Alternatively, the audio output unit 110 may be an output terminal connectable to an audio playback device such as earphones or headphones. It is possible for the user to listen to audio played back by the moving image editing application, via the audio output unit 110.

The data communication unit 111 is an interface such as a USB, an SD, a PCI Express or an SATA, and is capable of data communication with various storage media such as a USB memory, an SD card, and an SSD. The user can import moving image data and audio data obtained by moving image shooting, via the data communication unit 111, and save the imported data to the HDD 104 or the like. Also, the user can edit moving image data and audio data saved on the HDD 104 or the like with the moving image editing application. Alternatively, the user can also import moving image data and audio data from devices such as a camera, a PC, and a smartphone (not shown) via the network 120. The method of importing moving image data and audio data to the information processing apparatus 100 is not specifically limited.

The server 130 is a server for sharing part of the processing of the information processing apparatus 100, and is a server such as a personal computer (PC) or the like. The processing shared by the server 130 in the present embodiment is not specifically limited, and is, for example, processing relating to moving image editing and machine learning.

The server 130 has a CPU 131, a ROM 132, a RAM 133, an HDD 134, a GPU 135, and a network communication unit 136. These constituent elements of the server 130 are connected to each other via a system bus 137. The functions of the CPU 131, the ROM 132, the RAM 133, the HDD 134, the GPU 135, and the network communication unit 136 are respectively similar to the CPU 101, the ROM 102, the RAM 103, the HDD 104, the GPU 105, and the network communication unit 106 of the information processing apparatus 100. In general, however, the server 130 often has higher performance and larger capacity hardware resources than the information processing apparatus 100. Thus, when the hardware resources of the information processing apparatus 100 alone are insufficient, it is possible to efficiently perform processing by using the hardware resources of the server 130. However, all processing may be completed with only the information processing apparatus 100. Accordingly, the image processing system illustrated in FIG. 1A includes the information processing apparatus 100 and the server 130, but the image processing system of the present embodiment may not include the server 130.

### Functional Configuration of Image Processing System

FIG. 1B is a diagram showing a functional configuration that is realized by the hardware of the image processing system shown in FIG. 1A cooperating with a program (software). In FIG. 1B, the image processing system includes an area selection unit 141, a subject-type determination unit 142, a subject vector acquisition unit 143, a subject deletion unit 144, an audio-type determination unit 145, an audio vector acquisition unit 146, a type match determination unit 147, and an audio deletion unit 148. Also, the software of the present embodiment includes a moving image editing application. The moving image editing application operates as a result of the CPU 101 executing a program stored in the ROM 102 or the HDD 104, with the RAM 103 as a work area.

The area selection unit 141 selects any area within the angle of view of any one frame (area selection frame) of moving image data displayed on the display unit 109. For example, the area selection unit 141 selects an area designated by the user, in accordance with an instruction given by the user via the operation input unit 108. Also, the area selection frame is, for example, a frame designated by the user from the moving image data.

The subject-type determination unit 142 determines the type (e.g., person, dog, car, or other) of subjects included in the area (selected area) selected by the area selection unit 141 and outputs information indicating the determined type. Determination of the type of subject is realized by, for example, using an image of the selected area as an input and performing inference using a trained model (first machine learning model) configured to identify the types of subjects included in input images.

In the present embodiment, any known technology can be used for machine learning. For example, the subject-type determination unit 142 uses an image-specific trained model. In generation of an image-specific trained model, an image-specific trained model that outputs the types of subjects corresponding to images is generated, using images to be identified as input data and information (e.g., person, dog, car, or other) on the subject types of the images serving as input data as supervisory data. Specific algorithms for machine learning include Nearest Neighbor, Naïve Bayes, Decision Tree, Support Vector Machine, and the like. Also, other algorithms include deep learning, which utilizes a neural network to generate feature values and connection weights for learning. Any of these algorithms that are applicable can be used as appropriate and applied to the present embodiment.

In an inference phase, the image-specific trained model uses an image of the selected area as input data and outputs information (e.g., person, dog, car, or other) indicating the type of subject included in the image.

Note that the hardware used in generation of the trained model and in inference that is based on the trained model in the present embodiment is not specifically limited, and, for example, one or more, or all, of the CPU 101, the GPU 105, the CPU 131 and the GPU 135 may be used. Also, a different apparatus not illustrated may be used.

The subject vector acquisition unit 143 calculates a velocity vector of a subject detected through the type determination by the subject-type determination unit 142. For example, the subject vector acquisition unit 143 tracks the subject in several frames before and after the area selection frame and calculates the velocity vector of the subject from the amount of movement of the subject. The subject can be tracked, for example, by using machine learning technologies to detect the subject in each frame, similarly to the subject-type determination unit 142. Alternatively, the subject may be tracked by pattern matching of pixel values between frames, without using machine learning technologies. The hardware used to calculate the velocity vector of the subject is not specifically limited, and, for example, one or more, or all, of the CPU 101, the GPU 105, the CPU 131 and the GPU 135 may be used.

The subject deletion unit 144 deletes the subject detected by the subject-type determination unit 142 from the area selection frame. Also, simply deleting the subject from the area selection frame will result in a moving image that is unnatural, and thus the subject deletion unit 144 complements the background by assimilating the area from which the subject was deleted into the background. Also, if a corresponding subject is present within the angle of view in frames other than the area selection frame, the subject deletion unit 144 similarly deletes the subject and complements the background. The hardware used in deletion of subjects is not specifically limited, and, for example, one or more, or all, of the CPU 101, the GPU 105, the CPU 131 and the GPU 135 may be used.

The audio-type determination unit 145 analyzes the audio data corresponding to the frame in which the subject is deleted by the subject deletion unit 144, and outputs information (e.g., person, dog, car, or other) indicating the type of audio included in the audio data. Determination of the type of audio is realized, for example, by using audio data as an input and performing inference using a trained model (second machine learning model) configured to identify the type of subject corresponding to each audio component included in the input audio data.

In the present embodiment, any known technology can be used for machine learning. For example, the audio-type determination unit 145 uses an audio-specific trained model. In generation of an audio-specific trained model, an audio-specific trained model that outputs the types of subjects corresponding to audio is generated, using audio to be identified as input data and information (e.g., person, dog, car, or other) on the types of subjects, corresponding to the audio serving as input data, as supervisory data. Various algorithms can be used as the specific algorithm for machine learning, similarly to the case of the subject-type determination unit 142.

In an inference phase, the audio-specific trained model uses audio as input data and outputs information (e.g., person, dog, car, or other) indicating the type of subject corresponding to each audio component included in the audio.

Note that the hardware used in generation of the trained model and in inference that is based on the trained model in the present embodiment is not specifically limited, and, for example, one or more, or all, of the CPU 101, the GPU 105, the CPU 131 and the GPU 135 may be used. Also, a different apparatus not illustrated may be used.

The audio vector acquisition unit 146 calculates the position and velocity vector of the audio. An example of the method of calculating the position and velocity vector of the audio will be described below. For example, in the case where audio data is recorded using two microphones, the audio vector acquisition unit 146 specifies the position of the audio of the subject by the difference in arrival times of sound reaching the two microphones. Thereafter, the audio vector acquisition unit 146 calculates the velocity vector of the audio of the subject, based on movement of the position of the audio of the subject and the time axis of the audio data. Also, a configuration may be adopted in which the position and velocity vector of the audio source are more easily calculated, by recording the audio data with a microphone array that uses three or more microphones or with a directional microphone. The hardware used in calculating the velocity vector of audio is not specifically limited, and, for example, one or more, or all, of the CPU 101, the GPU 105, the CPU 131 and the GPU 135 may be used. Also, a different apparatus not illustrated may be used.

The type match determination unit 147 determines whether an audio component of a type matching the type (e.g., person, dog, car, or other) of the subject that is deleted is present, by comparing the subject type determined by the subject-type determination unit 142 with the audio type determined by the audio-type determination unit 145. Also, the type match determination unit 147 determines whether there is an audio velocity vector that corresponds to the velocity vector of the subject that is deleted, by comparing the position and velocity vector of the subject calculated by the subject vector acquisition unit 143 with the position and velocity vector of the audio calculated by the audio vector acquisition unit 146. If there is a corresponding audio velocity vector, the audio vector acquisition unit 146 can determine that the audio (audio component) is the same type as the subject that is deleted. This is because, in the case where the subject type cannot be correctly determined due to reasons such as insufficient training of the aforementioned image-specific learning model or audio-specific learning model, the audio component corresponding to the subject that is deleted is detectable, by using a different function called velocity vector calculation. Also, the type match determination unit 147 may use only the type information obtained by the subject-type determination unit 142 and the audio-type determination unit 145, and not use the velocity vectors. Alternatively, the type match determination unit 147 may use only the velocity vectors, and not use the type information obtained by the subject-type determination unit 142 and the audio-type determination unit 145. In this way, the method for identifying the audio component corresponding to a subject that is deleted from moving image data is not specifically limited, and various methods including those described here can be used.

The audio deletion unit 148 separates and deletes the audio component determined by the type match determination unit 147 to correspond to the subject that is deleted from the other audio components. Audio components other than the audio component corresponding to the subject that is deleted are not deleted. Any known technology can be used in separation and deletion of audio components. To illustrate one example of multiple technologies, the audio deletion unit 148 determines the type of audio using an audio-specific trained model similar to that described in relation to the audio-type determination unit 145, and separates the audio components by type. At this time, the audio deletion unit 148 can generate audio data for which only a specific audio type has been deleted, by performing a Fourier transform on the audio data, treating the audio data as spectral information and masking the spectrum of the audio type to be deleted, and reconstructing the audio data by performing an inverse Fourier transform.

### Flow of Image Processing

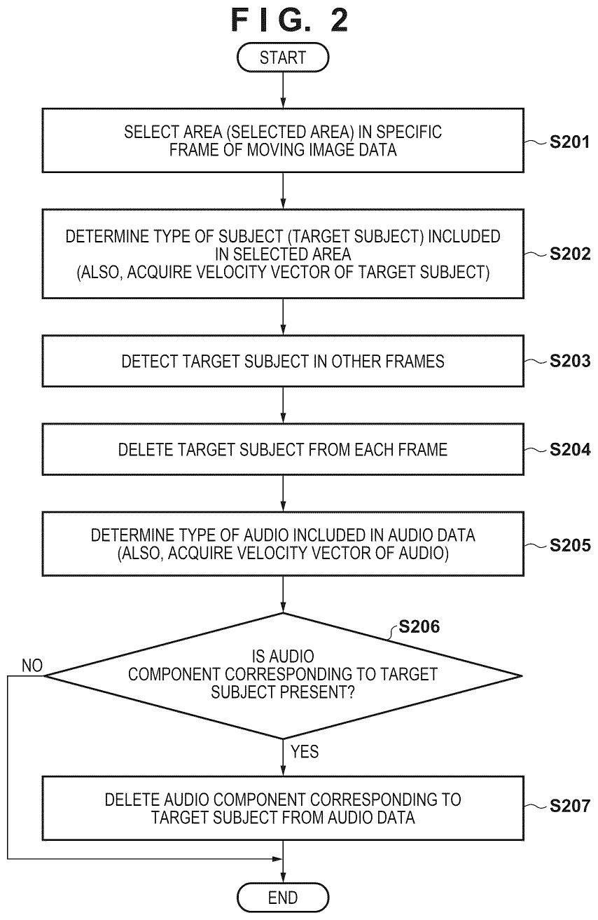

FIG. 2 is a flowchart of image processing executed by the image processing system. The image processing targets moving image data accompanied by audio data. As aforementioned, audio data and moving image data are stored on the HDD 104, for example. The processing of this flowchart starts when the function for deleting a subject is selected on the user interface of the moving image editing application by the user of the information processing apparatus 100.

Note that the CPU 101 performs overall control of this flowchart. Also, the processing of the steps of this flowchart is performed by the units shown in FIG. 1B. The hardware for realizing the functions of the units shown in FIG. 1B is not specifically limited, and is, for example, realized by one or more, or all, of the CPU 101, the GPU 105, the CPU 131 and the GPU 135, as far as technically possible.

In step S201, the area selection unit 141 selects a specific area (selected area) in a specific frame (area selection frame) among the plurality of frames of moving image data. The selected area is an area designated by the user, for example.

In step S202, the subject-type determination unit 142 determines the type (first type) of a subject (target subject) included in the selected area. The target subject is thereby detected and the type thereof is identified. Additionally, the subject vector acquisition unit 143 may calculate (acquire) a velocity vector, spanning a plurality of frames, of the target subject.

In step S203, the subject-type determination unit 142 detects the target subject in other frames (frames other than the area selection frame) of the moving image data.

In step S204, the subject deletion unit 144 deletes the target subject from each of the one or more frames (target frames) in which the target subject is detected in the subject detection of step S202 or step S203. Following deletion of the target subject, the subject deletion unit 144 complements the background by assimilating the area of the deleted subject into the background. For example, in the case where the target subject appears within the angle of view of the 201st to 300th frames of moving image data consisting of 500 frames, the target subject is deleted from the 201st to 300th frames and the background of these frames is complemented.

In step S205, the audio-type determination unit 145 determines the types of audio included in the audio data (types of respective subjects corresponding to respective audio components). Additionally, the audio vector acquisition unit 146 may calculate (acquire) a velocity vector, spanning a plurality of frames, of the audio component corresponding to the target subject.

In step S206, the type match determination unit 147 performs detection of an audio component corresponding to the target subject in the audio data and determines whether an audio component corresponding to the target subject is present. If an audio component corresponding to the target subject is present, the processing proceeds to step S207, and, if not, the processing of this flowchart ends.

Audio detection (detection of an audio component corresponding to the target subject) by the type match determination unit 147 is performed based on the target subject type determined in step S202 and the audio type determined in step S205. For example, consider the case where the target subject type is “car” and the audio types are “car” and “person”. In this case, the audio data includes an audio component corresponding to car, and the audio component corresponding to car is detected as an audio component corresponding to the target subject. Alternatively, the type match determination unit 147 may use the velocity vectors acquired in steps S202 and S205 to detect an audio component corresponding to the target subject, instead of or in addition to the types determined in steps S202 and S205. In the case of using the velocity vectors, the type match determination unit 147 is able to detect the audio component corresponding to the target subject in (each frame of) the audio data, by comparing the velocity vector of the target subject with the velocity vector of the audio component corresponding to the target subject.

In step S207, the audio deletion unit 148 separates and deletes the audio component corresponding to the target subject from the audio data. Audio components other than the audio component corresponding to the target subject are not deleted.

Note that, even in the case where the target subject is not included in the angle of view at the time of moving image shooting, if the target subject emits audio near a microphone of the image capturing apparatus (camera), there is a possibility that an audio component of the target subject will be recorded in the audio data. Thus, there is a possibility that an audio component corresponding to the target subject will be detected in step S206, in audio data corresponding to a frame in which the target subject was not detected in step S203. Accordingly, if an audio component corresponding to the target subject is present, the audio deletion unit 148, in step S207, is able to delete that audio component from the audio data, even with respect to frames in which the target subject is not included. For example, consider the case where the target subject appears within the angle of view of the 201st to 300th frames of moving image data consisting of 500 frames, and the audio component corresponding to the target subject is present in audio data corresponding to the 101st to 400th frames. In this case, when the audio-type determination unit 145 performs processing for determining the audio type on all of the audio data in step S205, the audio component corresponding to the target subject is detected from the portion of audio data corresponding to the 101st to 400th frames. Therefore, the audio deletion unit 148 is able to delete the audio component corresponding to the target subject, targeting the 101st to 400th frames in which the audio component corresponding to the target subject is present.

Also, the period during which the target subject is present within the angle of view may be taken into consideration when determining whether the audio component corresponding to the target subject is present with respect to frames in which the target subject is not present. For example, the audio-type determination unit 145 may determine the type of audio for each predetermined period, with respect to audio data corresponding to periods before and after a period in which the subject is present within the angle of view. The predetermined period is, for example, set as a period of predetermined length (e.g., 10 frame period), before and after a period in which the subject is present within the angle of view. The audio-type determination unit 145 may repeatedly set the predetermined period in order of increasing temporal distance from the period in which the subject is present within the angle of view, until the audio component corresponding to the target subject is no longer present. Alternatively, the audio-type determination unit 145 may perform a computation for predicting the frame in which the audio component corresponding to the target subject disappears, based on the velocity vector calculated by the subject vector acquisition unit 143 or the audio vector acquisition unit 146 mentioned above, or the transition in volume of audio corresponding to a subject of the same type as the type of the target subject, and the corresponding audio component may be deleted in frames up to the predicted frame.

### Example of Deletion of Target Subject and Corresponding Audio Component

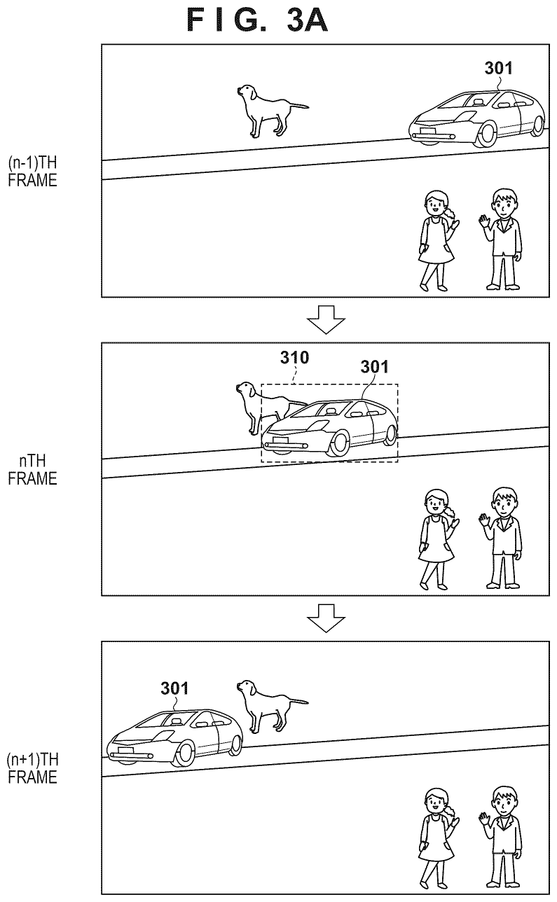

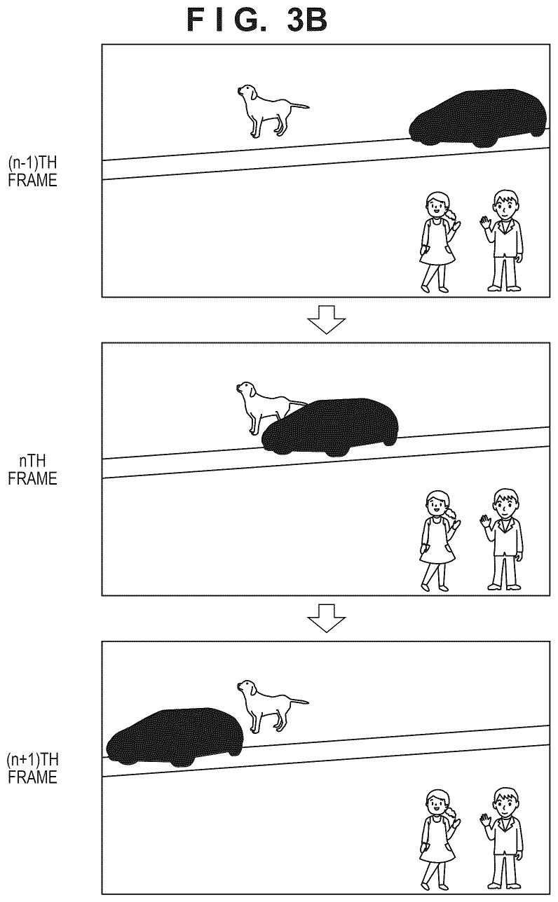

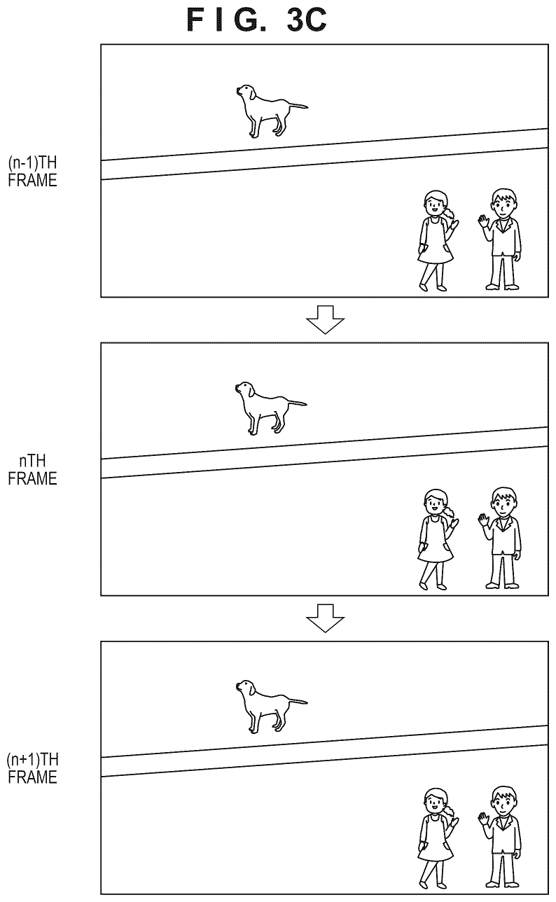

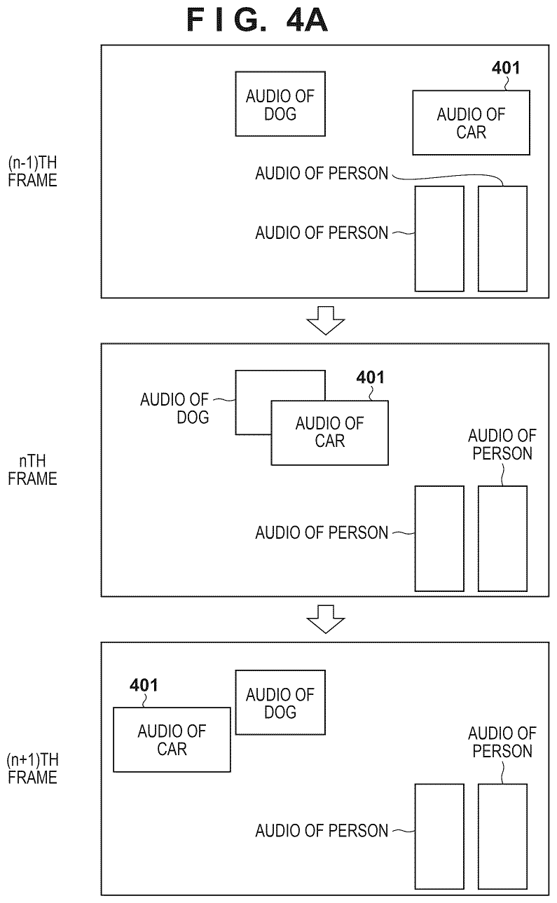

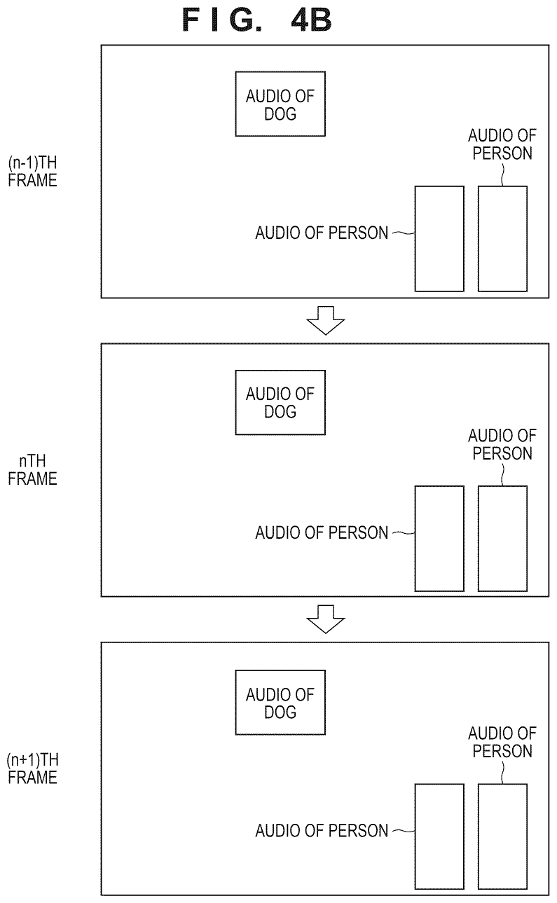

An example of deletion of a target subject and a corresponding audio component will be shown, with reference to FIGS. 3A to 3C and FIGS. 4A and 4B.

FIG. 3A is a diagram showing an example of three consecutive frames of moving image data. In these three frames, a car 301 moves from right to left. Subjects other than the car 301 are stationary.

The user is assumed to have specified an area 310 in step S201 of FIG. 2, in a state where the middle frame (nth frame) in FIG. 3A is displayed on the display unit 109. The area selection unit 141 selects the area 310, in response to designation of the area 310 by the user. This processing corresponds to step S201 of FIG. 2.

Note that the area 310 shown in FIG. 3A is rectangular, but the shape and method of designating the area 310 are not specifically limited. For example, the area 310 may be circular. Also, a configuration may be adopted in which the user designates the area 310 by circling a desired area by hand.

The subject-type determination unit 142 determines that the type of subject included in the area 310 is car. The subject-type determination unit 142 then performs detection of car, which is the target subject, in other frames of the moving image data. As a result, the car 301 is also detected in the upper and lower frames in FIG. 3A. This processing corresponds to steps S202 and S203 of FIG. 2.

Next, the subject deletion unit 144 deletes the car 301 from each frame in which the car 301 is detected, as shown in FIG. 3B. Then, the subject deletion unit 144 complements the background by assimilating the area of the car 301 that is deleted into the background, as shown in FIG. 3C. This processing corresponds to step S204 in FIG. 2.

FIG. 4A is a conceptual diagram of audio data corresponding to the three frames shown in FIG. 3A. The audio-type determination unit 145 determines the type of audio included in the audio data of these three frames. The type match determination unit 147 then detects an audio component (audio 401 of car) corresponding to the car 301 in FIG. 3A. This processing corresponds to steps S205 and S206 in FIG. 2.

Next, the audio deletion unit 148 deletes the audio component (audio 401 of car) corresponding to the car 301. As a result, as shown in FIG. 4B, the audio data corresponding to the three frames includes the audio components of a dog and people but no longer includes the audio component corresponding to the car 301. This processing corresponds to step S207 in FIG. 2.

Note that, in the case where frames other than the three frames shown in FIG. 4A also include the audio component corresponding to the car 301, the audio deletion unit 148 similarly also deletes the audio component corresponding to the car 301 from these frames.

### Summary of First Embodiment

As described above, according to the first embodiment, in the case where a specific subject (subject of first type) is deleted from moving image data accompanied by audio data, an audio component corresponding to the deleted subject is deleted from the audio data. Thus, when playing back a moving image with audio, playback of audio in which there remains an audio component corresponding to a subject that is not displayed because it was deleted can be prevented. Accordingly, with the present embodiment, it is possible to delete a specific subject from a moving image with audio, while suppressing degradation in quality of the moving image with audio.

Note that the specific procedure of the image processing described in FIG. 2 above is only an example of the processing procedure for realizing prevention of playback of audio in which there remains an audio component corresponding to a subject that is not displayed because it was deleted. Any configuration that realizes deletion of a specific subject from moving image data accompanied by audio data and deletion of an audio component corresponding to the subject that is deleted from audio data is embraced in the scope of technical ideas of the present embodiment. Accordingly, to further generalize the first embodiment, the image processing system detects a specific subject (subject of first type) among a plurality of frames of moving image data accompanied by audio data, and deletes the subject of the first type from one or more frames, among the plurality of frames, in which the subject of the first type is detected. Also, the image processing system detects an audio component corresponding to the subject of the first type in the audio data, and deletes the audio component corresponding to the subject of the first type from the audio data.

### Second Embodiment

The first embodiment described a configuration in which a subject to be deleted from moving image data is determined first, and then an audio component corresponding to the determined subject is deleted from audio data. In contrast, the second embodiment describes a configuration in which an audio component to be deleted from audio data is determined first, and then a subject corresponding to the determined audio component is deleted from moving image data. Note that, in the second embodiment, the basic configuration including the hardware configuration of the image processing system (FIG. 1A) is similar to the first embodiment. The following description focuses mainly on the differences from the first embodiment.

### Functional Configuration of Image Processing System

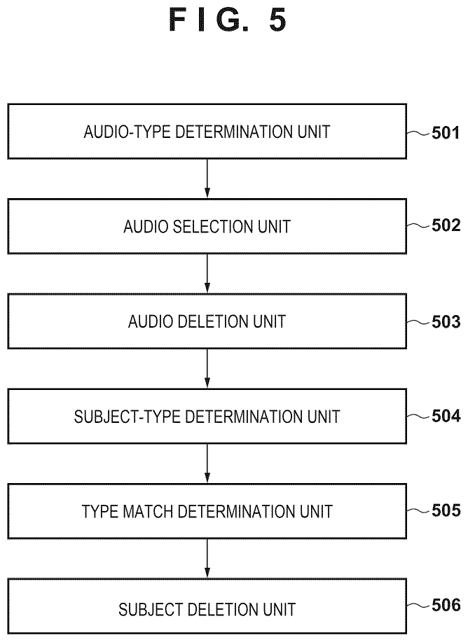

FIG. 5 is a diagram showing a functional configuration that is realized by the hardware of the image processing system shown in FIG. 1A cooperating with a program (software). In FIG. 5, the image processing system includes an audio-type determination unit 501, an audio selection unit 502, an audio deletion unit 503, a subject-type determination unit 504, a type match determination unit 505, and a subject deletion unit 506.

The audio-type determination unit 501 has generally the same function as the audio-type determination unit 145. The audio-type determination unit 501, however, determines the type of audio included in the audio data, for a period designated by the user out of the entire period of the audio data or for the entire period of the audio data, and outputs information (e.g., person, dog, car, or other) indicating the type of audio.

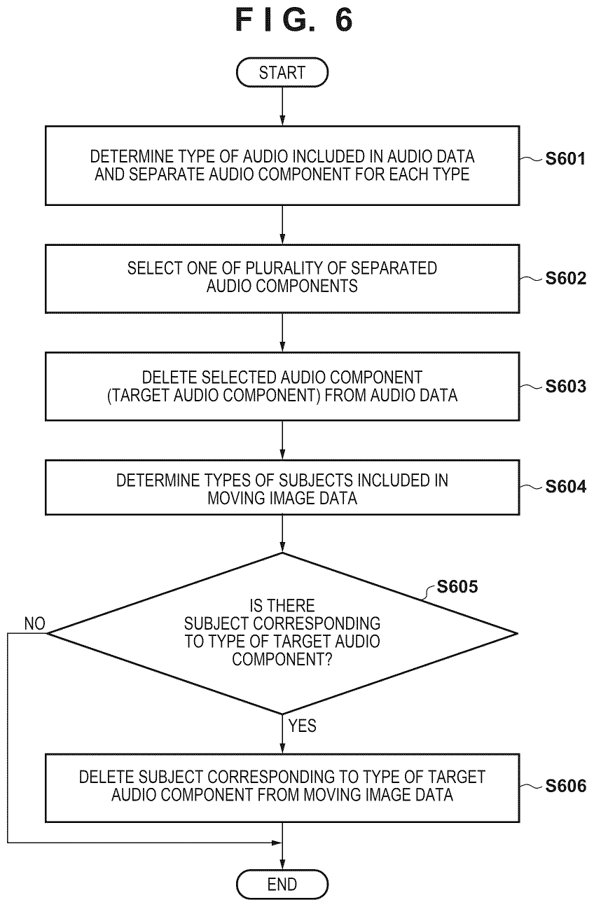

The function of the audio selection unit 502 will be described below with reference to FIG. 6. The function of the audio deletion unit 503 is similar to the audio deletion unit 148.

The subject-type determination unit 504 has generally the same function as the subject-type determination unit 142. The subject-type determination unit 142, however, determines the type of a subject included in a specific area of a specific frame, whereas the subject-type determination unit 504 analyzes all frames for the period corresponding to the audio component deleted by the audio deletion unit 503. Also, since the user does not specify an area, the subject-type determination unit 504 analyzes all of the pixels within the frame and outputs information (e.g., person, dog, car, or other) including the type of each subject included within the frame.

The function of the type match determination unit 505 is similar to the type match determination unit 147. The function of the subject deletion unit 506 is similar to the subject deletion unit 144.

### Flow of Image Processing

FIG. 6 is a flowchart of image processing executed by the image processing system. The image processing targets moving image data accompanied by audio data. Similarly to the first embodiment, audio data and moving image data are recorded on the HDD 104, for example. The processing of this flowchart starts when the function for deleting a subject is selected on the user interface of the moving image editing application by the user of the information processing apparatus 100.

Note that the CPU 101 performs overall control of this flowchart. Also, the processing of the steps of this flowchart is performed by the units shown in FIG. 5. The hardware for realizing the functions of the units shown in FIG. 5 is not specifically limited, and is, for example, realized by one or more, or all, of the CPU 101, the GPU 105, the CPU 131 and the GPU 135, as far as technically possible.

In step S601, the audio-type determination unit 501 determines the type of audio included in the audio data, separates the audio component for each type, and displays the type of each audio component on the display unit 109.

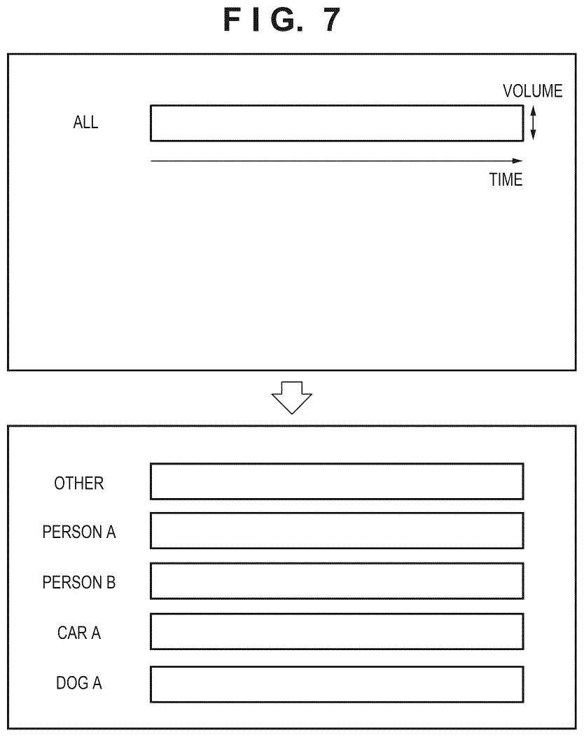

An example of the processing in step S601 will be described, with reference to FIG. 7. The upper half of FIG. 7 is a conceptual diagram of audio data to be processed. “ALL” conceptually indicates audio data including all of the audio components, with the horizontal axis indicating time and the vertical axis indicating volume. The bottom half of FIG. 7 is a conceptual diagram of separated audio components. Audio components whose type cannot be determined are separated as “other” audio components. Hereinafter, an example of the case where the audio data is separated into person A, person B, car A, dog A, and other audio components will be described.

In step S602, the audio selection unit 502 selects a specific audio component corresponding to a specific type from among the audio components separated in step S601. Here, the audio selection unit 502 may select an audio component designated by the user. Hereinafter, an example of the case where the user designates an audio component corresponding to car A will be described. Also, in moving image data consisting of 500 frames, the audio component corresponding to car A is assumed to be included in the audio data corresponding to the 101st to 400th frames.

In step S603, the audio deletion unit 503 deletes the audio component (target audio component) selected in step S602 from the audio data. Note that audio components other than the selected audio component are not deleted. For example, the audio component corresponding to car A in the audio data corresponding to the 101st to 400th frames is deleted.

In step S604, the subject-type determination unit 504 determines the types of subjects included in the moving image data. For example, the subject-type determination unit 504 determines the subject type, targeting the 101st to 400th frames corresponding to the deleted audio component. In the present embodiment, unlike the first embodiment, an area of a frame is not selected by the area selection unit 141. Thus, the subject-type determination unit 504 targets all of the pixels within each frame for analysis, and outputs information (e.g., person, dog, car, or other) indicating the type of each subject included in the analyzed frame.

Note that the processing for determining the subject type in step S604 is not limited to targeting frames corresponding to the deleted audio component. For example, the subject-type determination unit 504 may perform the processing for determining the subject type on all of the frames of moving image data.

In step S605, the type match determination unit 505 determines whether a subject corresponding to the type of the target audio component is present in the moving image data, based on the determination result in step S604. For example, in the case where the audio component of car A is the target audio component (audio component deleted in step S603), the type match determination unit 505 determines whether car is included in the determination result in step S604. If a subject corresponding to the type of the target audio component is present in the moving image data, the processing proceeds to step S606, and, if not, the processing of this flowchart ends.

In step S606, the subject deletion unit 506 deletes the subject corresponding to the type of the target audio component from each frame of the moving image data (each frame in which the subject corresponding to the type of the target audio component is detected through the processing of steps S604 and S605). Following deletion of the subject, the subject deletion unit 506 complements the background by assimilating the area of the deleted subject into the background.

### Summary of Second Embodiment

As described above, according to the second embodiment, an audio component corresponding to a specific subject (subject of first type) is selected in audio data, and the selected audio component is deleted from the audio data. Also, the subject corresponding to the audio component that is deleted is deleted from moving image data corresponding to the audio data. Thus, when playing back a moving image with audio, playback of audio in which there remains an audio component corresponding to a subject that is not displayed because it was deleted can be prevented. Accordingly, with the present embodiment, it is possible to delete a specific subject from a moving image with audio, while suppressing degradation in quality of the moving image with audio.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An image processing system comprising at least one processor and/or at least one circuit which functions as:
a subject detection unit configured to detect, among a plurality of frames of moving image data accompanied by audio data, a subject of a first type;
a subject deletion unit configured to delete the subject of the first type from one or more frames, among the plurality of frames, in which the subject of the first type is detected;
an audio detection unit configured to detect, in the audio data, an audio component corresponding to the subject of the first type; and
an audio deletion unit configured to delete the audio component corresponding to the subject of the first type from the audio data.

2. The image processing system according to claim 1, wherein
the subject detection unit identifies, based on an image of a first area of a first frame among the plurality of frames, a type of a subject included in the first area, and
the first type is the type of the subject included in the first area.

3. The image processing system according to claim 2, wherein
the subject detection unit identifies the type of the subject included in the first area, by performing inference using a first machine learning model with the image of the first area as an input.

4. The image processing system according to claim 2, wherein the at least one processor and/or the at least one circuit further functions as:
an area selection unit configured to select the first area in the first frame, in accordance with an instruction given by a user.

5. The image processing system according to claim 2, wherein the at least one processor and/or the at least one circuit further functions as:
a subject vector acquisition unit configured to acquire a velocity vector, spanning the plurality of frames, of the subject included in the first area; and
an audio vector acquisition acquire a velocity vector, spanning the plurality of frames, of an audio component corresponding to the subject included in the first area, and
wherein the audio detection unit detects, in the audio data, the audio component corresponding to the subject of the first type, by comparing the velocity vector of the subject included in the first area with the velocity vector of the audio component corresponding to the subject included in the first area.

6. The image processing system according to claim 1, wherein
the audio detection unit detects, in the audio data, the audio component corresponding to the subject of the first type, by performing inference using a second machine learning model with the audio data as an input.

7. The image processing system according to claim 1, wherein
the audio detection unit detects, in the audio data, a plurality of audio components corresponding to subjects of different types, by performing inference using a second machine learning model with the audio data as an input,
the at least one processor and/or the at least one circuit further functions as an audio selection unit configured to select an audio component from among the plurality of audio components, and
the first type is a type of a subject corresponding to the audio component selected from among the plurality of audio components.

8. An image processing method executed by an image processing system, comprising:
detecting, among a plurality of frames of moving image data accompanied by audio data, a subject of a first type;
deleting the subject of the first type from one or more frames, among the plurality of frames, in which the subject of the first type is detected;
detecting, in the audio data, an audio component corresponding to the subject of the first type; and
deleting the audio component corresponding to the subject of the first type from the audio data.

9. A non-transitory computer-readable storage medium which stores a program for causing a computer to execute an image processing method comprising:
detecting, among a plurality of frames of moving image data accompanied by audio data, a subject of a first type;
deleting the subject of the first type from one or more frames, among the plurality of frames, in which the subject of the first type is detected;
detecting, in the audio data, an audio component corresponding to the subject of the first type; and
deleting the audio component corresponding to the subject of the first type from the audio data.
